(19) United States
(12) Patent Application Publication
(10) Pub. No.: US 2019/0265088 A1
(43) Pub. Date: Aug. 29, 2019

(54) SYSTEM ANALYSIS METHOD, SYSTEM ANALYSIS APPARATUS, AND PROGRAM

(71) Applicant: NEC Corporation, Minato-ku, Tokyo (JP)

(72) Inventor: Masanao NATSUMEDA, Tokyo (JP)

(73) Assignee: NEC Corporation, Minato-ku, Tokyo (JP)

(21) Appl. No.: 16/342,598

(22) PCT Filed: Oct. 21, 2016
(86) PCT No.: PCT/JP2016/081275

§ 371 Date: Apr. 17, 2019

(51) Int. Cl. G01D 18/00

(52) U.S. Cl. CPC G01D 18/00

(57) ABSTRACT

A system analysis apparatus includes a history information generation part generating, based on sensor values output by a plurality of sensors provided in a system, history information representing in a time series whether or not the sensor value(s) output by each of the plurality of sensors is abnormal, and/or whether or not a relationship between the sensor values output by different sensors is abnormal, a clustering part classifying the plurality of sensors into a plurality of groups, based on the history information, and a cluster hierarchy structuring part structuring a hierarchy of the plurality of groups by using causality information that indicates causality between the sensor values output by the plurality of sensors.

### TECHNICAL FIELD

The present invention relates to a system analysis method, a system analysis apparatus, and a program, and more particularly to a system analysis method, a system analysis apparatus, and a program for analyzing a state of a system.

### BACKGROUND ART

In recent years, system analysis apparatuses that analyze a state of a system, based on sensor data obtained from components of the system have been used. Analysis processing performed by such a system analysis apparatus is performed for the purpose of safely and efficiently operating the system. Further, one type of the analysis processing is processing of detecting abnormality of a system by performing multivariate analysis on sensor data. In such analysis processing, when the system analysis apparatus detects abnormality of the system, the system analysis apparatus notifies an operator and the system of the occurrence of abnormality. As a result, the abnormality or a sign of the abnormality is detected at an early stage, and therefore initial action of countermeasures can be taken at an early stage to minimize damage.

Examples of a system to be subjected to the analysis processing include a unit or a system that includes elements that have influence over each other, such as an information and communication technology (ICT) system, a chemical plant, a power generating station, and a power facility.

Incidentally, some system analysis apparatuses provide information that contributes to determining a cause when the system analysis apparatuses detect abnormality of a system. One example of such provided information is a sensor name relating to abnormality. Patent Literatures 1 and 2 disclose such a technique of notifying an operator and a system of a sensor name(s) relating to abnormality as described above.

Specifically, a process monitoring diagnostic apparatus disclosed in Patent Literature 1 provides a sensor name having a high abnormality degree at a time point when a system analysis apparatus detects abnormality, as a sensor name relating to abnormality.

A time series data processing apparatus disclosed in Patent Literature 2 estimates an abnormality propagation order from time series data in a certain time period, and rearranges sensor names relating to abnormality in the estimated abnormality propagation order to provide the rearranged sensor names.

Further, Patent Literature 3 describes a technique of properly detecting occurrence of failure by, when performance information does not satisfy a relationship represented by a correlation function, extracting a time period in such a state as a failure time period.

Patent Literature 4 describes a technique of performing abnormality detection by using output signals of sensors provided in a facility, and creating a network of the sensor signals, based on information of degrees of influence of the sensor signals over abnormality.

Further, Patent Literature 5 describes a technique of collecting and grouping sensor data items having a large mutual connection in a behavior of pieces of sensor data among a plurality of sensor data items, and building a link model representing a mutual relationship between the data items in each group and a mutual relationship between the groups.

### CITATION LIST

### Patent Literature

Patent Literature 1: JP 2014-096050A

Patent Literature 2: JP 2014-115714A

Patent Literature 3: WO 2010/032701

Patent Literature 4: JP2013-041448A

Patent Literature 5: JP2011-243118A

### SUMMARY

### Technical Problem

All the contents disclosed in Patent Literatures 1 to 5 are incorporated and described herein by reference thereto. The following analysis has been made by the inventor of the present invention.

When events including a plurality of types of abnormalities and signs of abnormalities are detected, the apparatuses disclosed in Patent Literatures 1 to 5 may possibly output the detected plurality of events in a mixed-up manner. Therefore, the apparatuses disclosed in Patent Literatures 1 to 5 include a problem that an operator fails to properly grasp a state of a system in such a case.

In view of this, a problem is to, when a plurality of events occur in a system to be analyzed, separate the events and output information corresponding to each event. It is an object of the present invention to provide a system analysis method, a system analysis apparatus, and a program for contributing to solving such a problem.

### Solution to Problem

According to a first aspect of the present invention, a system analysis method includes the steps of: generating, based on sensor values output by a plurality of sensors provided in a system, history information representing in a time series whether or not the sensor value(s) output by the each of plurality of sensors is abnormal, and/or whether or not a relationship between the sensor values output by different sensors is abnormal; classifying the plurality of sensors into a plurality of groups, based on the history information; and structuring (i.e., formulating) a hierarchy of the plurality of groups by using causality information that indicates causality between the sensor values output by the plurality of sensors.

According to a second aspect of the present invention, a system analysis apparatus includes: a history information generation part configured to generate, based on sensor values output by a plurality of sensors provided in a system, history information representing in a time series whether or not the sensor value(s) output by each of the plurality of sensors is abnormal, and/or whether or not a relationship between the sensor values output by different sensors is abnormal; a clustering part configured to classify the plurality of sensors into a plurality of groups, based on the history information; and a cluster hierarchy structuring part configured to structure a hierarchy of the plurality of groups by using causality information that indicates causality between the sensor values output by the plurality of sensors.

According to a third aspect of the present invention, a program is configured to cause a computer to execute processes of: generating, based on sensor values output by a plurality of sensors provided in a system, history information representing in a time series whether or not the sensor value(s) output by each of the plurality of sensors is abnormal, and/or whether or not a relationship between the sensor values output by different sensors is abnormal; classifying the plurality of sensors into a plurality of groups, based on the history information; and structuring a hierarchy of the plurality of groups by using causality information that indicates causality between the sensor values output by the plurality of sensors.

### ADVANTAGEOUS EFFECTS OF INVENTION

According to the system analysis method, the system analysis apparatus, and the program of the present invention, when a plurality of events occur in a system to be analyzed, abnormalities can be separated, and information corresponding to each event can be output.

### BRIEF DESCRIPTION OF THE DRAWINGS

FIG. 1 is a block diagram illustrating an example of a configuration of a system analysis apparatus according to one example embodiment.

FIG. 2 is a block diagram illustrating a schematic configuration of a system analysis apparatus according to a first example embodiment.

FIG. 3 is a block diagram illustrating an example of a specific configuration of the system analysis apparatus according to the first example embodiment.

FIG. 4 is a diagram illustrating an example of an output result of the system analysis apparatus according to the first example embodiment.

FIG. 5 is a diagram illustrating an example of the output result of the system analysis apparatus according to the first example embodiment.

FIG. 6 is a diagram illustrating an example of the output result of the system analysis apparatus according to the first example embodiment.

FIG. 7 is a flowchart illustrating an example of operation of the system analysis apparatus according to the first example embodiment.

FIG. 8 is a block diagram illustrating an example of a specific configuration of a system analysis apparatus according to a second example embodiment.

FIG. 9 is a flowchart illustrating an example of operation of the system analysis apparatus according to the second example embodiment.

FIG. 10 is a block diagram illustrating an example of a configuration of a computer that implements the system analysis apparatuses according to the first and second example embodiments.

### DESCRIPTION OF EMBODIMENTS

First of all, an outline of one example embodiment is described. Note that the reference signs in the drawings added in this outline are given solely for the sake of better understanding, and are not intended to limit the present invention to the illustrated mode(s).

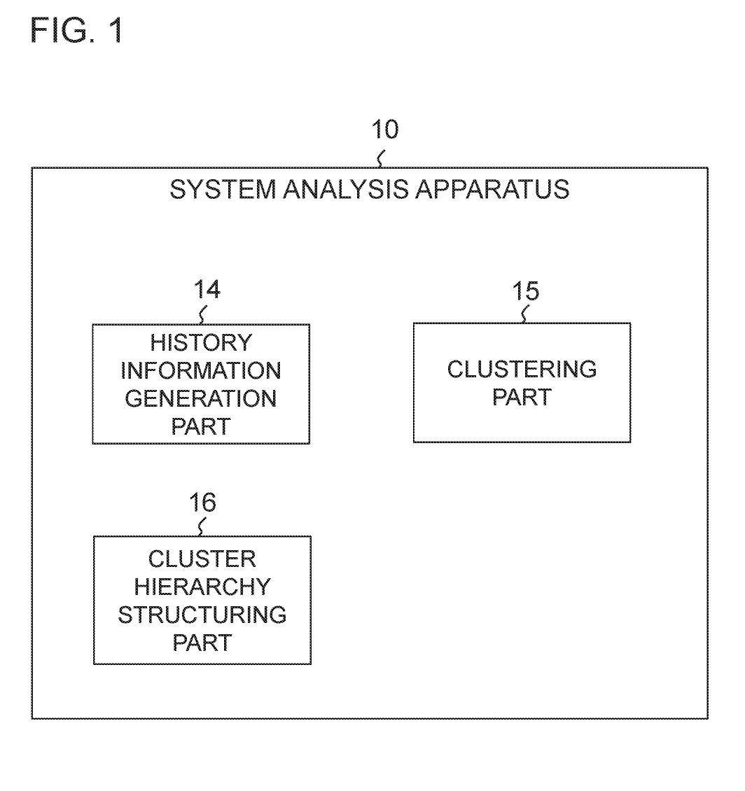

FIG. 1 is a block diagram illustrating an example of a configuration of a system analysis apparatus 10 according to the one example embodiment. With reference to FIG. 1, the system analysis apparatus 10 includes a history information generation part 14, a clustering part 15, and a cluster hierarchy structuring part 16.

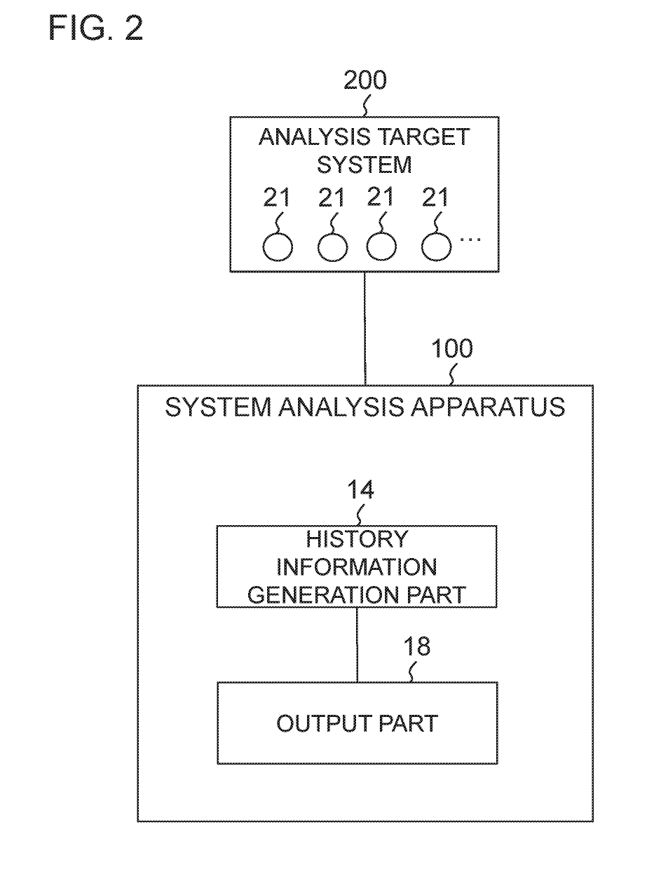

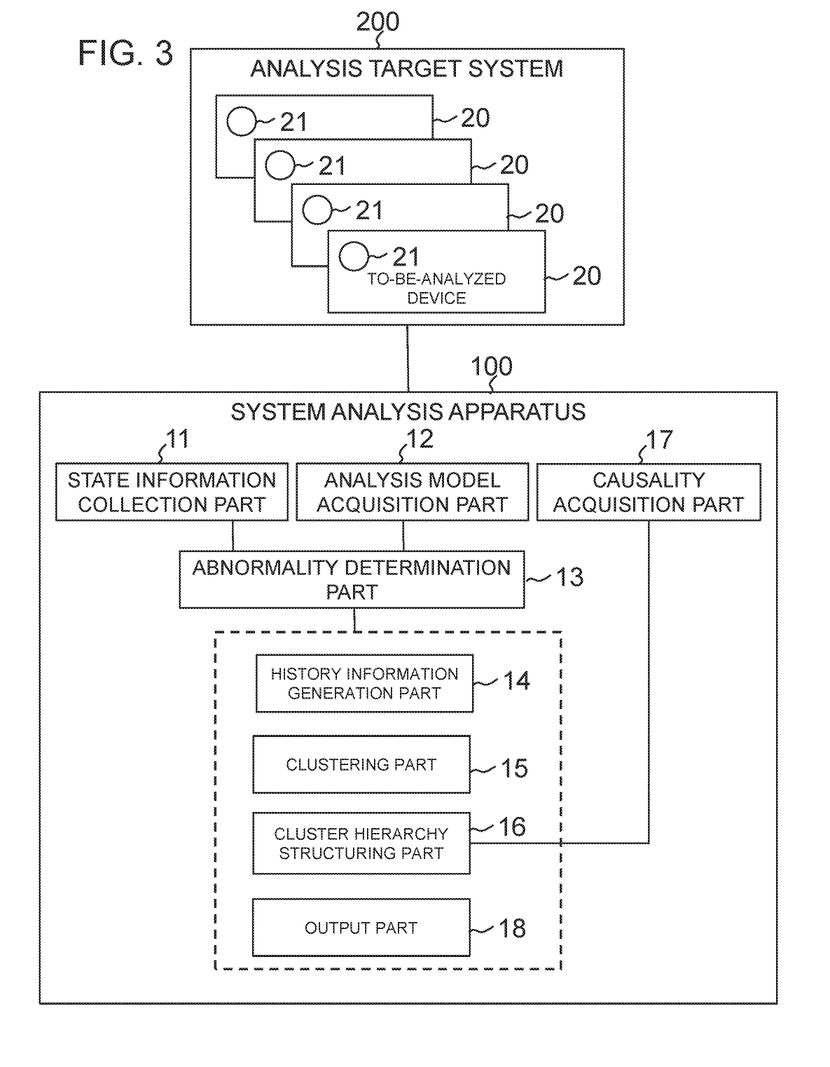

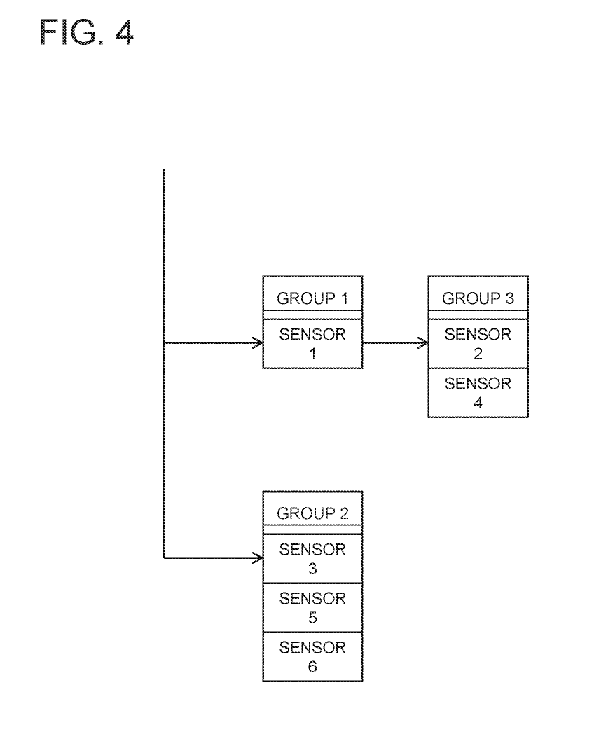

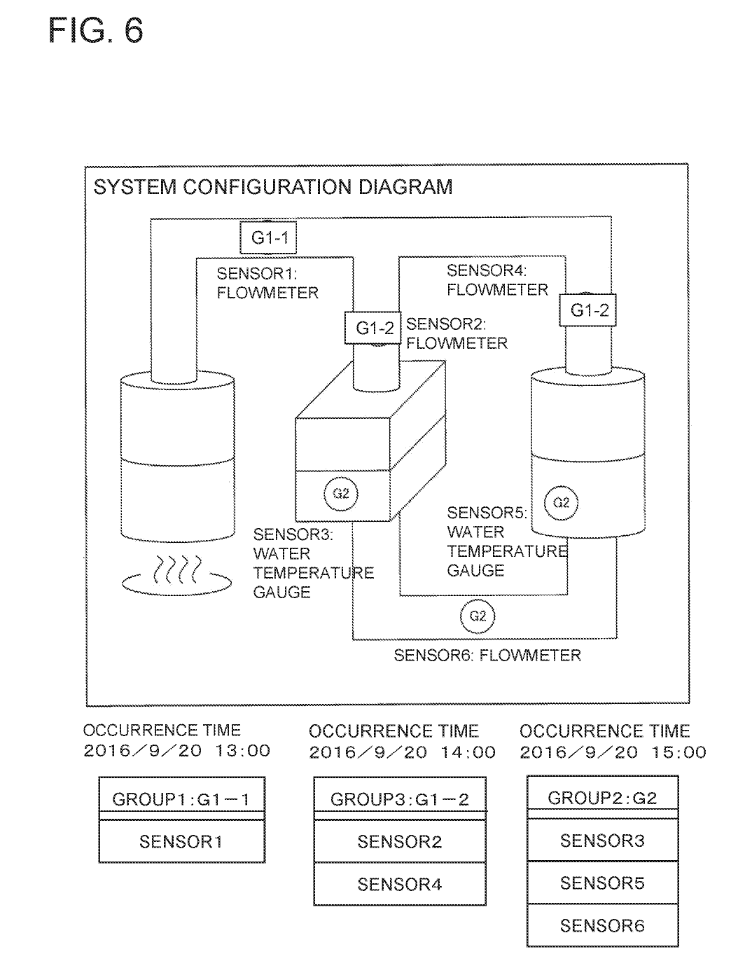

The history information generation part 14 generates, based on sensor values (e.g., measurement values measured via sensors 21 in FIG. 2 and FIG. 3) that are output by a plurality of sensors (sensors 21) provided in a system (e.g., an analysis target system 200 in FIG. 2 and FIG. 3), history information (e.g., time series data) that represents in a time series whether or not the sensor value(s) output by each of the sensors is abnormal, and/or whether or not a relationship between the sensor values output by different sensors is abnormal. The clustering part 15 classifies the plurality of sensors into a plurality of groups (e.g., groups 1 to 3 in FIG. 4 to FIG. 6), based on the history information. The cluster hierarchy structuring part 16 structures a hierarchy (e.g., FIG. 4 and FIG. 6) of the plurality of groups by using causality information (e.g., causality information that is defined in advance or that is estimated based on the sensor values) that indicates causality between the sensor values output by the plurality of sensors.

According to the system analysis apparatus 10 thus configured, a user is presented with the groups of the sensors obtained with reference to the sensor history information, based on the sensor values, and the hierarchy structure of the groups. At this time, the plurality of sensors are classified into the groups according to events. Therefore, according to this example embodiment, when a plurality of events occur in the analysis target system, the events can be separated into each event, and information corresponding to each event can be output. Further, owing to the structuring of the hierarchy of the groups, even if events caused in a chain reaction due to one event of a root cause are obtained as a plurality of groups, causality (or causalities) of the events can be grasped as a hierarchy structure of the groups. Accordingly, an operator can grasp a state of the system more accurately.

“Abnormality of a sensor value output by a sensor” and “(abnormality of) a relationship between sensor values output by different sensors” may be hereinafter also simply referred to as “abnormality of a sensor” and “(abnormality of) a relationship between sensors,” respectively.

### Example Embodiment 1

Next, a system analysis apparatus, a system analysis method, and a program according to a first example embodiment are described with reference to FIG. 2 to FIG. 7.

### Configuration

First, a schematic configuration of a system analysis apparatus according to this example embodiment is described with reference to FIG. 2. FIG. 2 is a block diagram illustrating an example of a schematic configuration of a system analysis apparatus 100 according to this example embodiment.

As illustrated in FIG. 2, the system analysis apparatus 100 according to this example embodiment is a apparatus that analyzes a system to be analyzed (hereinafter referred to as an “analysis target system”) 200. The system analysis apparatus 100 includes a history information generation part 14 and an output part 18.

The history information generation part 14 generates, based on a processing result of sensor values output by a plurality of sensors 21 provided in the analysis target system 200, history information of at least either each sensor 21 or each relationship between the sensors 21. Note that the number of the sensors 21 provided in the analysis target system 200 is not limited to four. The output part 18 presents a user with cluster information of classifying the sensors 21 into one or more groups based on the generated history information and the causality information between the sensors 21. Here, the cluster information contains an identifier that indicates each sensor 21 included in each group, and hierarchy structure information between the groups.

The sensor values output by the sensors 21 are various values obtained from components of the analysis target system 200. Examples of the sensor values include a measurement value acquired via the sensor 21 provided in a component of the analysis target system 200. Examples of such a measurement value include an opening degree of a valve, a height of a liquid level, a temperature, a flow rate, a pressure, an electric current, a voltage, and the like. Further, examples of the sensor value(s) also include an estimation value that is calculated by using these measurement values. Further, examples of the sensor values also include a control signal output by an information processing apparatus for changing a state of the analysis target system 200 into a desired operation state.

As described above, in this example embodiment, a user is presented with the groups of the sensors 21 obtained with reference to the history information that is based on the processing result of the sensor values, and the hierarchy structure of the groups. At this time, the plurality of sensors 21 are classified into the groups according to events. Therefore, according to this example embodiment, when a plurality of events occur in the analysis target system 200, the events can be separated from one to another, and information corresponding to each event can be output. Further, owing to the structuring of the hierarchy of the groups, even if events caused in a chain reaction due to one event of (original) root cause are obtained as a plurality of groups, causality (or causalities) of the events can be grasped as a hierarchy structure of the groups. Consequently, an operator can grasp a state of the analysis target system 200 even more accurately.

Next, with reference to FIG. 3, the configuration of the system analysis apparatus 100 according to this example embodiment is more specifically described. FIG. 3 is a block diagram illustrating an example of a specific configuration of the system analysis apparatus 100 according to this example embodiment.

As illustrated in FIG. 3, the system analysis apparatus 100 of this example embodiment may further include a state information collection part 11, an analysis model acquisition part 12, an abnormality determination part 13, a clustering part 15, a cluster hierarchy structuring part 16, and a causality acquisition part 17, in addition to the history information generation part 14 and the output part 18 described above. Each of these components will be described later.

As illustrated in FIG. 3, the system analysis apparatus 100 is connected to the analysis target system 200 via a network. The system analysis apparatus 100 analyzes abnormality that has occurred in the analysis target system 200, based on the sensor values of the analysis target system 200, and outputs an analysis result and additional information. Note that, in FIG. 3, the rectangle in the broken lines enclosing the history information generation part 14, the clustering part 15, the cluster hierarchy structuring part 16, and the output part 18 indicate that each of the functional blocks enclosed in the broken lines operates based on information output by the abnormality determination part 13.

In this example embodiment, the analysis target system 200 includes one or more to-be-analyzed devices (i.e., target device to be analyzed) 20, and each of the to-be-analyzed devices 20 is an analysis target. One example of the analysis target system 200 is a power generation plant system. In this case, examples of the to-be-analyzed device 20 include a turbine, a feedwater heater, a condenser, and the like. Further, the to-be-analyzed device 20 may include, for example, an element that connects apparatuses, such as a pipe and a signal line. Further, the analysis target system 200 may be an entire system such as the above-mentioned power generation plant system, or may be a part of a certain system for implementing a part of the functions of the certain system. Further, the analysis target system 200 may be a unit or a system that constituted with elements that have influence over each other, such as an information and communication technology (ICT) system, a chemical plant, a power generating station, and a power facility.

In each to-be-analyzed device 20, the sensor 21 provided in the to-be-analyzed device 20 measures a sensor value(s) at every predetermined timing, and transmits the measured sensor value(s) to the system analysis apparatus 100. The sensor 21 in this example embodiment is not limited to what physically exists as hardware, such as a usual measurement device. Specifically, the sensor 21 includes software, an output source of a control signal, and the like, and this as a whole is referred to as a “sensor.”

The “sensor value(s)” is a value(s) obtained from the sensor 21. Examples of the sensor value(s) include a measurement value(s) measured by a measurement apparatus installed in a facility, such as an opening degree of a valve, a height of a liquid level, a temperature, a flow rate, a pressure, an electric current, and a voltage. Other examples of the sensor value(s) include an estimation value(s) calculated from the measurement value(s), a value(s) of a control signal, and the like. In the following, each sensor value(s) is represented by a numerical value such as an integer and a decimal. Note that, in FIG. 3, one sensor 21 is provided in one to-be-analyzed device 20. However, the number of the sensor(s) 21 provided in one to-be-analyzed device 20 is not specifically limited. Further, examples of a case where abnormality occurs in the sensor value also include a case where abnormality (failure) occurs in the sensor 21 itself, as well as a case where abnormality occurs in a target measured by the sensor 21.

In this example embodiment, one data item is assigned to each sensor 21 that corresponds to the sensor value obtained from each to-be-analyzed device 20. A set of sensor values collected at timings regarded as the same timing from the to-be-analyzed devices 20 is referred to as “state information.” Further, a set of data items that correspond to the respective sensor values contained in the state information is referred to as a “data item group.”

In other words, in this example embodiment, the state information includes a plurality of data items. Here, “collected at timings regarded as the same timing” may refer to measurement at the same time or at times within a predetermined range in the to-be-analyzed devices 20. Further, “collected at timings regarded as the same timing” may refer to collection in a series of collection processing performed by the system analysis apparatus 100.

In this example embodiment, a storage device (not illustrated in FIG. 3) configured to store the sensor values acquired by the to-be-analyzed devices 20 may be provided between the to-be-analyzed devices 20 and the system analysis apparatus 100. Examples of such a storage device include a data server, a distributed control system (DCS), supervisory control and data acquisition (SCADA), a process computer, and the like. Further, when such a configuration is adopted, each of the to-be-analyzed devices 20 acquires a sensor value(s) at any timing, and causes the storage device to store the acquired sensor value(s). Then, the system analysis apparatus 100 reads out the sensor values stored in the storage device at a predetermined timing.

Now, each functional block of the system analysis apparatus 100 is described in detail. First, the state information collection part 11 collects state information from the analysis target system 200. The analysis model acquisition part 12 acquires an analysis model of the analysis target system 200. The causality acquisition part 17 acquires causality information between the sensors 21 (i.e., information indicating causality between the sensor values output by the plurality of sensors 21).

The “analysis model” is a model used to determine whether each sensor 21 is either normal or abnormal depending on the sensor value of each of the plurality of sensors 21, and to calculate an abnormality degree that indicates a degree of abnormality of each sensor 21. The analysis model is constructed based on all or a part of the plurality of data items forming the state information of the analysis target system 200. The analysis model is used to determine normality and abnormality for each sensor 21 and to calculate an abnormality degree when the state information collected by the state information collection part 11 is input.

The analysis model may be a set of a plurality of models. When the analysis model is a set of a plurality of models, results of determination of normality or abnormality for each sensor 21 may overlap. Further, the results of determination of normality or abnormality for each sensor 21 that overlap among the analysis models may not be consistent. The analysis model may be constructed based on a time series of the state information obtained concerning the analysis target system 200.

Further, in this example embodiment, the analysis model may be stored in a storage device (not illustrated in FIG. 3) of the system analysis apparatus 100, or may be input from the outside. In the former case, the analysis model acquisition part 12 acquires an analysis model from the storage device. In contrast, in the latter case, the analysis model acquisition part 12 acquires an analysis model from the outside via an input device such as a keyboard, a network, a storage medium, or the like.

The causality information is information that indicates causality between the plurality of sensors 21. The causality information is provided with respect to all or a part of the plurality of data items forming the state information of the analysis target system 200, and is used to impart a hierarchy structure to the groups. The causality information may contain an identifier that indicates presence or absence of causality between the sensors 21. As such an identifier, an identifier that can identify four types of causalities may be used. Specifically, a type that indicates absence of causality (one type), a type that indicates presence of bidirectional causality between two sensors 21 (one type), and types that indicate presence of causality from one of two sensors 21 toward the other (two types; one sensor 21 is alternated to correspond to both a cause and an effect) may be used as the identifier.

The causality information may be estimated from the time series of the state information acquired by the state information collection part 11, or may be estimated from (based on) outside information that is independent of the time series of the state information.

In the former case, for example, the causality acquisition part 17 uses a general data analysis technology to estimate the causality between the sensors 21 from the time series of the state information acquired by the state information collection part 11. Examples of this method include a method of estimating causality by calculating a cross correlation function while changing a time difference of two pieces of time series data, a method of using transfer entropy, a method of estimating a relationship between two sensors 21 with a regression formula and estimating causality from a time lag of a coefficient of the regression formula, a method of using cross mapping, and the like. The time series of the state information used to estimate the causality may be, for example, specified by the user when clustering is performed, or may be determined in accordance with a preset rule. When the time series of the state information to be used to estimate causality is determined in accordance with a preset rule, for example, the time series may range from a time point when clustering is performed to a time point preceding the time point when clustering is executed by a time period predetermined by the operator. The time series may range from a time point when clustering is performed to a time when the abnormality determination part 13 determines that a predetermined number of sensors 21 are abnormal. Further, the time series may range from a time point when clustering is performed to a time point further preceding the time when the abnormality determination part 13 determines that a predetermined number of sensors 21 are abnormal by a predetermined time period.

In contrast, in the latter case, the causality acquisition part 17 may estimate causality between the sensors 21, based on knowledge of an expert and/or an equation relating to the system operation, for example.

Further, in this example embodiment, the causality information may be stored in a storage device (not illustrated in FIG. 3) of the system analysis apparatus 100, or may be input from the outside. In the former case, the causality acquisition part 17 acquires the causality information from the storage device. In contrast, in the latter case, the causality acquisition part 17 acquires the causality information from the outside via an input device such as a keyboard, a network, a storage medium, or the like.

The abnormality determination part 13 applies the analysis model acquired by the analysis model acquisition part 12 to the collected state information to thereby determine or calculate at least any one of each sensor 21 and each relationship between the sensors 21, and outputs a result of the determination or the calculation.

In this example embodiment, the history information generation part 14 generates history information, based on the result output by the abnormality determination part 13 in a predetermined time period. The history information contains time series data concerning abnormality or normality of (each) sensor 21 or relationship between the sensors 21 included in the analysis model (i.e., abnormality/normality of data output by individual sensors 21, or abnormality/normality of a relationship between sensor values output by different sensors 21) in a predetermined time period. Specifically, the history information contains an identifier of each data item of the sensor 21 or each combination of data items of the sensors 21, and a determination result (time series data) of normality or abnormality acquired along a time series for each data item or each combination of data items. Here, depending on analysis models, identifiers of the data items of the sensors 21 or the combination of the data items contained in the history information may overlap.

The history information contains one or more pieces of time series data (1) to (3) below, for example.
(1) “Time series data of determination result of normality or abnormality”

For example, the history information contains data that holds information indicating normality or abnormality as a determination result of determined data at each time of the determined data or at each time of state information to which the determined data belongs. Moreover, for example, when a plurality of determination results of normality or abnormality are obtained for one sensor 21, statistical processing may be applied to the plurality of determination results such that time series data of the determination results of normality or abnormality for the one sensor 21 may be generated. For example, such processing includes a case of determining normality or abnormality by majority at each time, a case of setting a threshold value for a total value of the determination results at each time and presetting a rule between a relationship of values of the total value and the threshold value and a determination result to determine normality or abnormality, and the like. Another type of processing includes the following processing; that is, a determination result of normality or abnormality of the sensors 21 is calculated from a graph pattern that is obtained by providing a determination result of normality or abnormality of a relationship between the sensors 21 as information to a graph structure in which the sensors 21 are represented as points and the relationship between the sensors 21 (e.g., a correlation model to be described later) is represented as a line. A calculation target of such processing may be a determination result at a certain time, or may be a determination result of a specific time period.
(2) “Time series data of feature amount generated from determination result of normality or abnormality”

For example, time series data of a feature amount contains information concerning a length of a time period in which normality or abnormality successively occurs. For example, the time series data of a feature amount may contain the number of times normality or abnormality successively or non-successively occurs in a predetermined time period. Further, for example, the time series data of a feature amount may contain information concerning a total of time periods in which normality or abnormality occurs.
(3) “Time series data of abnormality degree indicating degree of abnormality of sensor value”

Time series data of an abnormality degree of the sensor 21 contains a value estimating a degree of abnormality of the sensor 21. For example, the time series data of an abnormality degree of the sensor 21 may contain information concerning deviation between prediction and actual measurement of a sensor value (a difference between prediction and actual measurement (value) or an error rate of prediction and actual measurement) at a predetermined time. Further, for example, the time series data of an abnormality degree of the sensor 21 may contain an amount of contribution to the Q statistic or the T² statistic in multivariate statistical process control.

In this example embodiment, the history information generation part 14 may acquire information necessary for generating history information not only from the abnormality determination part 13 described above, but also from the analysis model acquisition part 12.

The clustering part 15 clusters each of the plurality of sensors 21 into one of more groups, based on the generated history information. For example, the clustering part 15 clusters the sensors 21 included in the analysis model into one or more groups, based on the above-mentioned time series data of a predetermined time period contained in the history information.

First, the clustering part 15 assigns a data item or a combination of data items to members of each group through a clustering algorithm. When a combination of data items (corresponding to a relationship between the sensors 21) is included as a member of the group, the clustering part 15 applies statistical processing to the combination of data items to estimate data items relating to abnormality and arranges that the members of the group are only of data items.

The clustering part 15 may cluster the data items or the combinations of data items by using clustering algorithm used in data mining such as Ising model clustering, k-means, x-means, non-negative matrix factorization (NMF), Convolutive-NMF, and affinity propagation.

The above-mentioned time series data in a predetermined time period contained in the history information may be time series data in which a one-dimensional feature amount (a scalar value, e.g., continuous time of abnormality) is defined at each time. In this case, the clustering part 15 may also use algorithm of change point detection or time series segmentation used in data mining, in addition to the above-mentioned algorithm of clustering used in data mining. Note that, in other examples, the feature amount contained in the history information is not limited to a one-dimensional feature amount.

The clustering part 15 may perform clustering a plurality of times by successively using results of clustering.

As the statistical processing performed on a combination of data items in order to estimate data items relating to abnormality, for example, a technique of graph pattern mining may be used. Specifically, a determination result of normality or abnormality of the sensors 21 may be calculated from a graph pattern that is obtained by providing a determination result of normality or abnormality of a relationship between the sensors 21 as information to a graph structure in which the sensors 21 are represented as points and the relationship between the sensors 21 (e.g., a correlation model to be described later) is represented as a line.

Further, the clustering part 15 estimates an abnormality start time of each group as cluster information. The abnormality start time of each group is estimated from pieces of history information assigned to each group when data items and combinations of data items are clustered. For example, a time when one of the data items and combinations of data items included in each group is determined to be abnormal for the first time is considered as a start time of abnormality. As another example, a time when one of the data items and combinations of data items included in each group is determined to be continuously abnormal is considered as a start time of abnormality.

The cluster hierarchy structuring part 16 imparts a hierarchy structure to the groups generated by the clustering part 15, based on the causality information between the sensors 21 acquired by the causality acquisition part 17 and the abnormality start time of each group.

When the cluster hierarchy structuring part 16 estimates that there is causality between groups, the cluster hierarchy structuring part 16 imparts a hierarchy structure to the groups based on a direction of cause and effect. In contrast, the cluster hierarchy structuring part 16 does not impart a hierarchy structure to groups that are recognized not to have causality with any group.

The cluster hierarchy structuring part 16 estimates a direction of cause and effect between groups, based on the abnormality start time of each group. Specifically, the cluster hierarchy structuring part 16 considers that a direction from a group having an earlier abnormality start time toward a group having a later abnormality start time is the direction of cause and effect.

The cluster hierarchy structuring part 16 calculates a total of the number of causalities in the estimated direction of cause and effect between all or a part of pairs of groups, and determines causality between groups, based on the total value(s). As a determination condition, for example, the cluster hierarchy structuring part 16 may use a condition that the total value is equal to or greater than a preset number. As a determination condition, the cluster hierarchy structuring part 16 may use a condition that a value obtained by dividing the total value by the number of combinations between members of two groups is equal to or greater than a preset number.

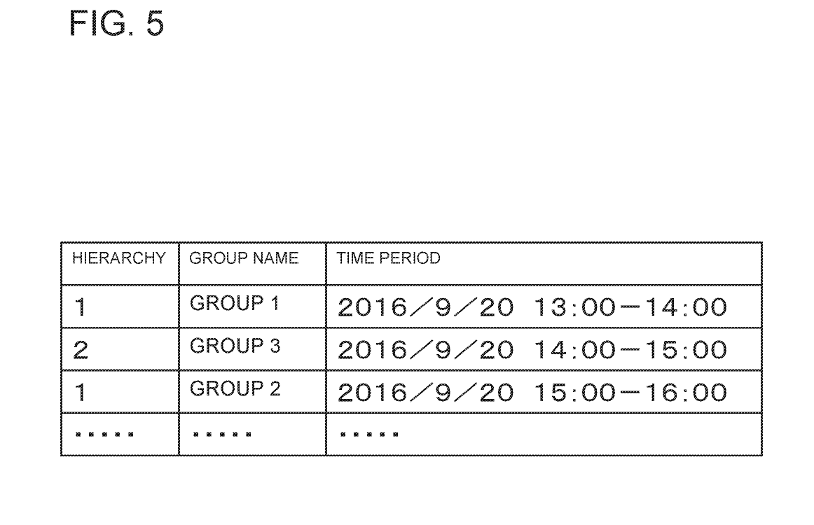

For example, as illustrated in FIG. 4, the output part 18 presents the user (e.g., an operator) or the system with the groups of the sensors 21 obtained by the clustering performed by the clustering part 15 and the hierarchy structure obtained by the calculation performed by the cluster hierarchy structuring part 16. For example, as illustrated in FIG. 5, the output part 18 may further output a result that estimates a range of time in which occurrence of abnormality is suspected, for each group of the sensors 21. Note that each of FIG. 4 and FIG. 5 merely illustrates one example of an output result of the system analysis apparatus 100 according to this example embodiment, and the output result is not limited to the illustrated mode.

Further, in this example embodiment, the output part 18 may output an abnormality degree, a statistical value of the abnormality degree, or a re-calculated value, at a predetermined time, of the sensors 21 that belong to the focused groups, in addition to the groups. Note that the method in which the output part 18 presents the groups of the sensors 21 is not limited to these methods.

The output part 18 may present the groups of the sensors 21 in a form of a list of sensor names. Further, as illustrated in FIG. 6, the output part 18 may present the groups of the sensors 21 on a system configuration diagram as markers (identifiers) that can identify a set of groups connected in a hierarchy structure and the hierarchy structure. In the latter case, i.e., in the case where the output part 18 presents the groups of the sensors 21 on a system configuration diagram as markers that can identify a set of groups connected in a hierarchy structure and the hierarchy structure, the output part 18 may arrange that a part of the markers corresponding to the hierarchy structure indicates the order of time at which occurrence of abnormality is suspected. The output part 18 may configure the markers such that the markers can distinguish groups that do not have a hierarchy structure and groups that have a hierarchy structure.

FIG. 6 is a diagram illustrating an example of an output result of the system analysis apparatus 100 according to this example embodiment. Note that the analysis target system illustrated in FIG. 6 is a power generation plant system. In FIG. 6, numbers immediately after G in G1-1, G1-2, and G2 are numbers added to a set of groups arranged to have a hierarchy, whereas numbers that follow a hyphen (-) are numbers added to a hierarchy within the set of groups.

Presence or absence of a hyphen in a label indicates presence or absence of a hierarchy structure. Note that, as the expression method of indicating presence or absence of a hierarchy structure, the output part 18 may use, not limited to a character string, another expression method using color, a shape, or the like. In FIG. 6, labels having a combination of these two types of numbers form markers that can identify groups and a hierarchy structure. Note that, as the expression method used at the time of enabling identification of the hierarchy structure and the set of groups connected in the hierarchy structure, the output part 18 may use, not limited to a character string, another expression method using color, a shape, or the like. Individual expression methods of the set of groups and the hierarchy structure are not limited to the illustrated mode, either. Further, the number of layers of a hierarchy is not limited to two layers, and the hierarchy may have a structure having more layers.

Further, the output part 18 may emphasize only a part of the hierarchy structure and the set of groups connected in the hierarchy structure to present.

Further, the output part 18 may present only a part of the hierarchy structure and the set of groups connected in the hierarchy structure.

The output part 18 may present the set of groups connected in the hierarchy structure by switching a set of groups to be displayed according to the order of time at which occurrence of abnormality is suspected. At this time, instead of completely switching display, the output part 18 may switch a set of groups to be emphasized. Further, the output part 18 may automatically perform such switching at predetermined time intervals. The output part 18 may repeat the series of display including such switching a predetermined number of times, or until the user performs operation.

Further, the output part 18 may display a part of groups in the set of groups connected in the hierarchy structure. At this time, instead of completely switching display, the output part 18 may switch a set of groups or groups to be emphasized.

The output part 18 may present the set of groups connected in the hierarchy structure by switching a set of groups to be displayed according to the order of time at which occurrence of abnormality is suspected. At this time, instead of completely switching display, the output part 18 may switch a set of groups to be emphasized. Further, the output part 18 may perform such switching according to operation of the user, or may automatically switch at predetermined time intervals. The output part 18 may repeat the series of display including such switching a predetermined number of times, or until the user performs operation.

Further, the output part 18 may present at least either causality information within a group or causality information between groups. When the output part 18 switches and displays both of the pieces of information, the output part 18 may perform such switching according to operation of the user, or may automatically switch at predetermined time intervals. The output part 18 may repeat the series of display including such switching a predetermined number of times, or until the user performs operation. Further, the output part 18 may display the causality information within a group and the causality information between groups by using different expression methods. For example, the output part 18 may express the causality information between groups by using a label assigned to each group, whereas the output part 18 may express the causality information within a group as an arrow extending from the sensor 21 of the cause to the sensor 21 of the result.

Further, the output part 18 may output time series data of an abnormality degree index (which indicates an abnormality degree) relating to a system or a apparatus with a symbol of each group attached in a time frame corresponding to the abnormality start time of each group. Outputting in such a manner can help integrally grasp abnormality degrees and transition of an abnormality state, and thus the user can efficiently grasp a state of the analysis target system 200.

Further, the output part 18 may present, as a pie chart or a list, ratios of physical amount types of the sensors 21 included in a group of the sensors 21 or in a set of groups, and a ratio of a line of sensors 21 included in a group of the sensors 21. Note that the “line” herein refers to a structural unit of a functional system. The “line” may be specified by the operator in advance.

### Operation

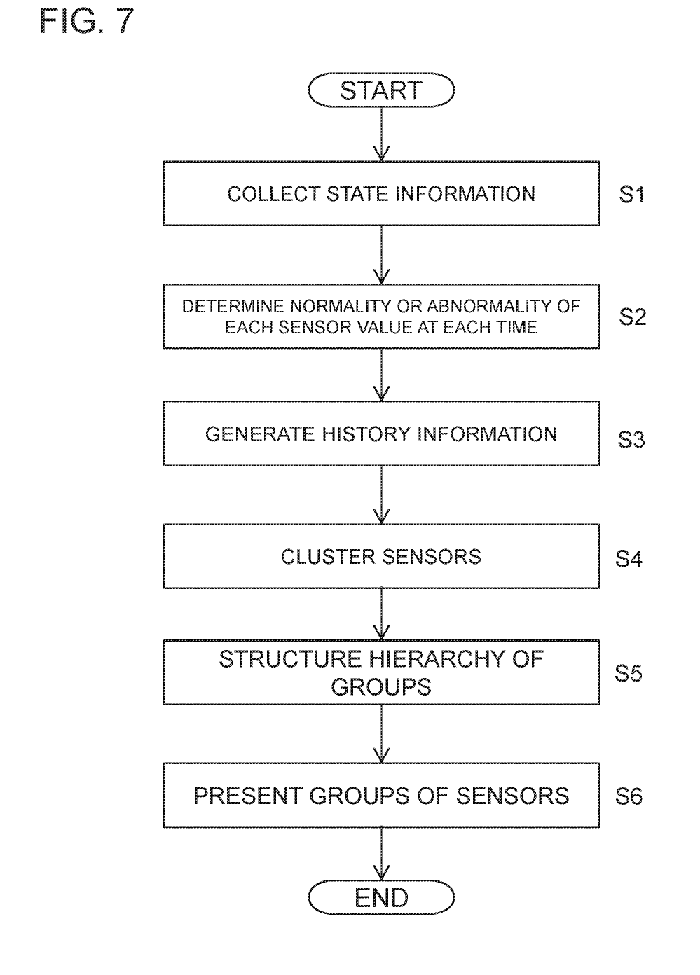

Next, operation of the system analysis apparatus 100 according to this example embodiment is described with reference to FIG. 7. FIG. 7 is a flowchart illustrating an example of the operation of the system analysis apparatus 100 according to this example embodiment. The description below refers to FIG. 2 and FIG. 3 as appropriate. In this example embodiment, a system analysis method is implemented by operating the system analysis apparatus 100. Therefore, the system analysis method according to this example embodiment is described by referring to the following operation of the system analysis apparatus 100.

Here, as one example, it is assumed that the analysis model acquisition part 12 has acquired an analysis model in advance. It is also assumed that the causality acquisition part 17 has acquired causality information between the sensors 21 in advance.

As illustrated in FIG. 7, the state information collection part 11 collects state information in a predetermined time period from the analysis target system 200 (Step S1).

Next, the abnormality determination part 13 determines sensor values contained in the state information at each time by using the analysis model that has been acquired by the analysis model acquisition part 12 in advance (Step S2). As one example, the abnormality determination part 13 determines to which of normality or abnormality the sensors 21 or a relationship between the sensors 21 belongs at each time. As another example, the abnormality determination part 13 determines an abnormality degree of the sensors 21 or a relationship between the sensors 21 at each time.

Next, the history information generation part 14 generates history information, based on determination results of the sensors 21 or the relationship between the sensors 21 obtained by the abnormality determination part 13 (Step S3). Specifically, the history information generation part 14 acquires determination results of normality or abnormality of the sensors 21 or the relationship between the sensors 21 obtained by the abnormality determination part 13 along a time series, and uses the determination results acquired along a time series (i.e., time series data) as history information.

Next, the clustering part 15 clusters the sensors 21 included in the analysis model into one or more groups, based on the history information generated in Step S3 (Step S4). Specifically, the clustering part 15 clusters the sensors 21, based on the time series data concerning abnormality or normality of each sensor 21 in a predetermined time period contained in the history information by using the above-mentioned clustering technique.

Next, the cluster hierarchy structuring part 16 structures a hierarchy of the groups generated in Step S4, based on the causality information between the sensors 21 that has been acquired by the causality acquisition part 17 (Step S5).

Next, the output part 18 presents the user (e.g., an operator), the system, and the like, with the groups of the sensors 21 obtained in the clustering in Step S4 and a hierarchy structure of the groups obtained in Step S5 (Step S6).

Through the above operation, the processing of the system analysis apparatus 100 ends. When state information is output from the analysis target system 200 after a predetermined time period elapses, the system analysis apparatus 100 executes Steps S1 to S6 again.

### Effects

As described above, in this example embodiment, even when a plurality of events are included, the system analysis apparatus 100 can separate the events from one another by clustering. Therefore, the system analysis apparatus 100 can output information for each event. Further, owing to the structuring of the hierarchy of the groups, even if events caused in a chain reaction due to one event of (original) root cause are obtained as a plurality of groups, causalities of the events can be grasped as a hierarchy structure of the groups. Therefore, the operator can grasp a state of the analysis target system 200 more accurately.

In other words, in this example embodiment, the sensors 21 are clustered based on time series data concerning abnormality or normality of all the sensors 21 included in the analysis model. Thus, the sensors 21 are clustered depending on change in the time series concerning the abnormality or normality. Therefore, even when a plurality of types of abnormalities successively occur and an occurrence time of each type of the abnormalities is different, the sensors 21 are classified for each type of the abnormalities. As a result, the user can obtain information for each type of the abnormalities. Moreover, according to this example embodiment, even if events caused in a chain reaction due to one event of root cause are obtained as a plurality of groups, causalities of the events can be grasped as a hierarchy structure of the groups. Therefore, the operator can grasp a state of the analysis target system 200 more accurately.

Next, variants of this example embodiment are described below. Note that, in the description below, differences from the above-mentioned first example embodiment is mainly described.

### Variant 1

In Variant 1, the history information generation part 14 determines, for each of the sensors 21, a length of time in which the sensor 21 is determined to be abnormal, and uses the determined length of time as history information. In variant 1, the history information contains an identifier of a data item of the sensor 21, and the length of time in which the sensor 21 is determined to be abnormal. The history information generation part 14 may determine the length of time in which the sensor 21 is determined to be abnormal, by calculating a ratio that the individual sensor 21 is determined to be abnormal in a predetermined time period and then multiplying the calculated ratio by the predetermined time period. As another method, the history information generation part 14 may determine the length of time in which the sensor 21 is determined to be abnormal, by adding up time periods in which the individual sensor 21 is determined to be abnormal in a predetermined time period. As still another method, the history information generation part 14 may determine the length of time in which the sensor 21 is determined to be abnormal, by adding up the number of times the individual sensor 21 is determined to be abnormal in a predetermined time period, or the number of times of transition from normality to abnormality.

Here, the length of time in which each sensor 21 is determined to be abnormal is also time series information concerning abnormality or normality. Therefore, also when Variant 1 is adopted, similar effects to the effects of the above-mentioned first example embodiment can be obtained. Further, the length of time in which the sensor 21 is determined to be abnormal is one-dimensional data. Thus, according to Variant 1, the clustering part 15 can execute calculation of clustering with fewer calculation resources than those in the above-mentioned first example embodiment.

### Variant 2

In Variant 2, the history information generation part 14 identifies, for each of the sensors 21, a length of time in which the sensor 21 is continuously determined to be abnormal, and uses the determined length of time as history information. In Variant 2, the history information contains an identifier of a data item or a combination of data items of each sensor 21, and a length of time (hereinafter referred to as “continuous abnormality time”) in which the sensor 21 is continuously determined to be abnormal with the latest time in a predetermined time period being an end point.

The history information generation part 14 may calculate a length of the continuous abnormality time by using statistical processing. This is because when sensor data fluctuates due to sensor noise or disturbance, a degree of abnormality may be low and determination of normality or abnormality may fluctuate between normality and abnormality.

Specifically, first, the history information generation part 14 divides a predetermined time period into a plurality of time periods. Subsequently, for each of the divided time periods, the history information generation part 14 determines whether a ratio of time determined to be abnormal is greater than a predetermined threshold value. Then, the history information generation part 14 identifies a group of a plurality of divided time periods in which results of the determination are successively abnormal with the latest time in the predetermined time period being an end point, and uses the determined length of the group of the divided time periods as the length of the continuous abnormality time. Note that overlap of the results of the determination of normality or abnormality for each sensor 21 or each relationship between the sensors 21 in the predetermined time period may be permitted, or may not necessarily be permitted.

The predetermined threshold value used to determine the divided time periods may be set by the user providing any numerical value. The predetermined threshold value may be set based on a confidence interval in Poisson distribution concerning the length of the divided time periods under an assumption that fluctuation of normality or abnormality is at random.

When temporary normality with an interval shorter than a predetermined length is detected and subsequently abnormality is detected, the history information generation part 14 may ignore the time period of normality (i.e., regard the time period as abnormality). Also with such a method, effective continuous abnormality time may be calculated.

Such continuous abnormality time is also time series data concerning abnormality or normality. Therefore, also when Variant 2 is adopted, similar effects to the effects of the above-mentioned first example embodiment can be obtained. Further, the continuous abnormality time is one-dimensional data. Thus, also in Variant 2, similarly to Variant 1, the clustering part 15 can perform calculation of clustering with a few calculation resources. Further, in Variant 2, the sensors 21 are clustered based on the continuous abnormality time. Thus, clustering in consideration of fluctuation in determination of normality or abnormality is carried out. Therefore, according to Variant 2, more accurate groups of the sensors 21 can be presented.

### Variant 3

In Variant 3, a calculation target of history information is limited only to a relationship between two sensors 21. Specifically, a combination of data items is limited to a combination of two sensors 21. This corresponds to a special case of the first example embodiment. Therefore, in Variant 3, an analysis model acquired by the analysis model acquisition part 12 is different from the analysis model of the above-mentioned first example embodiment.

In Variant 3, the analysis model acquisition part 12 acquires a set of one or more correlation models as an analysis model. The correlation model is configured to be capable of estimating a predetermined sensor value when a sensor value(s) of one or more predetermined sensors 21 is input to the correlation model. The correlation model includes a regression formula that estimates a specific sensor value by using one or more sensor values other than a data item of the specific sensor value, and an allowable range of an error of the estimation.

The abnormality determination part 13 applies the correlation model to collected state information to determine normality or abnormality for each of the sensors 21, i.e., for each of the correlation models, and then outputs a determination result.

In Variant 3, the history information generation part 14 identifies a length of time of continuous outputs that the correlation model is abnormality, and creates history information by using the identified length of time. The history information contains the length of time in which the correlation model is continuously determined to be abnormality with the latest time in a predetermined time period being an end point. Specifically, the history information contains an identifier of the correlation model, a data item included in the correlation model, and a length of time (hereinafter referred to as “correlation model abnormality continuous time”) in which the correlation model is continuously determined to be abnormality with the latest time in a predetermined time period being an end point.

The history information generation part 14 may calculate a length of the correlation model abnormality continuous time by using statistical processing. This is because when sensor data fluctuates due to sensor noise or disturbance, a degree of abnormality may be low and determination of normality or abnormality may fluctuate between normality and abnormality. Further, the history information generation part 14 may acquire information necessary for generating history information from the analysis model acquisition part 12 and the abnormality determination part 13.

Specifically, first, the history information generation part 14 divides a predetermined time period into a plurality of time periods. Subsequently, for each of the divided time periods, the history information generation part 14 determines whether a ratio of time determined to be abnormal is greater than a predetermined threshold value. Then, the history information generation part 14 identifies a group of a plurality of divided time periods in which results of the determination are successively abnormal with the latest time in the predetermined time period being an end point, and uses the identified length of the group of the divided time periods as the length of the correlation model continuous abnormality time. Note that overlap of the results of the determination of normality or abnormality for each sensor 21 in the predetermined time period may be permitted, or may not necessarily be permitted.

The predetermined threshold value used to determine the divided time periods may be set by the user providing any numerical value, or may be set based on a confidence interval in Poisson distribution concerning the length of the divided time periods under an assumption that fluctuation of normality or abnormality is at random.

In Variant 3, the clustering part 15 clusters the sensors 21 into one or more groups, based on time series data concerning abnormality or normality of all of the correlation models included in an analysis model in a predetermined time period.

Specifically, first, the clustering part 15 clusters the correlation models included in an analysis model into one or more groups, based on time series data concerning abnormality or normality of all of the correlation models included in the analysis model in a predetermined time period. Subsequently, the clustering part 15 clusters the sensors 21, based on the clustering result of the correlation models.

For example, the clustering part 15 counts, for each of the sensors 21, the number of times the sensor 21 appears as being included in the correlation model in each group, and then assigns each sensor 21 to the group having the largest number of times of appearance. At this event, if there are groups having the same value of the number of times, the sensors 21 may be assigned to the groups having the same value in an overlapped manner, or may be assigned to any one of the groups in accordance with a predetermined rule.

In Variant 3, the clustering part 15 may cluster the correlation models by using algorithm of clustering used in data mining such as

Ising model clustering, k-means, x-means, non-negative matrix factorization (NMF), Convolutive-NMF, and affinity propagation.

For example, the time series data concerning abnormality or normality of all of the correlation models in a predetermined time period may be a one-dimensional feature amount with respect to time (e.g., continuous time of abnormality and the like). In this case, the clustering part 15 may also use algorithm of change point detection or time series segmentation used in data mining, in addition to the algorithm of clustering used in data mining.

### Variant 4

In Variant 4, the cluster hierarchy structuring part 16 structures a hierarchy only between groups having the closest abnormality start time of the groups. Such configuration does not involve branches in the hierarchy structure of the groups, and can therefore reduce complexity of an output result.

### Program

A program according to this example embodiment causes a computer to execute Steps S1 to S6 illustrated in FIG. 7. When such a program is installed in a computer and is executed, the system analysis apparatus 100 and the system analysis method according to this example embodiment can be implemented. In this case, a central processing unit (CPU) of the computer performs processing while functioning as the state information collection part 11, the analysis model acquisition part 12, the abnormality determination part 13, the history information generation part 14, the clustering part 15, the cluster hierarchy structuring part 16, the causality acquisition part 17, and the output part 18.

The program according to this example embodiment may be executed by a computer system constructed with a plurality of computers. In this case, for example, each of the computers may function as any of the state information collection part 11, the analysis model acquisition part 12, the abnormality determination part 13, the history information generation part 14, the clustering part 15, the cluster hierarchy structuring part 16, the causality acquisition part 17, and the output part 18.

Further, the program according to this example embodiment is stored in a storage device of a computer that implements the system analysis apparatus 100, and is read out by a CPU of the computer to be executed. In this case, the program may be provided as a computer-readable storage medium, or may be provided via a network.

### Example Embodiment 2

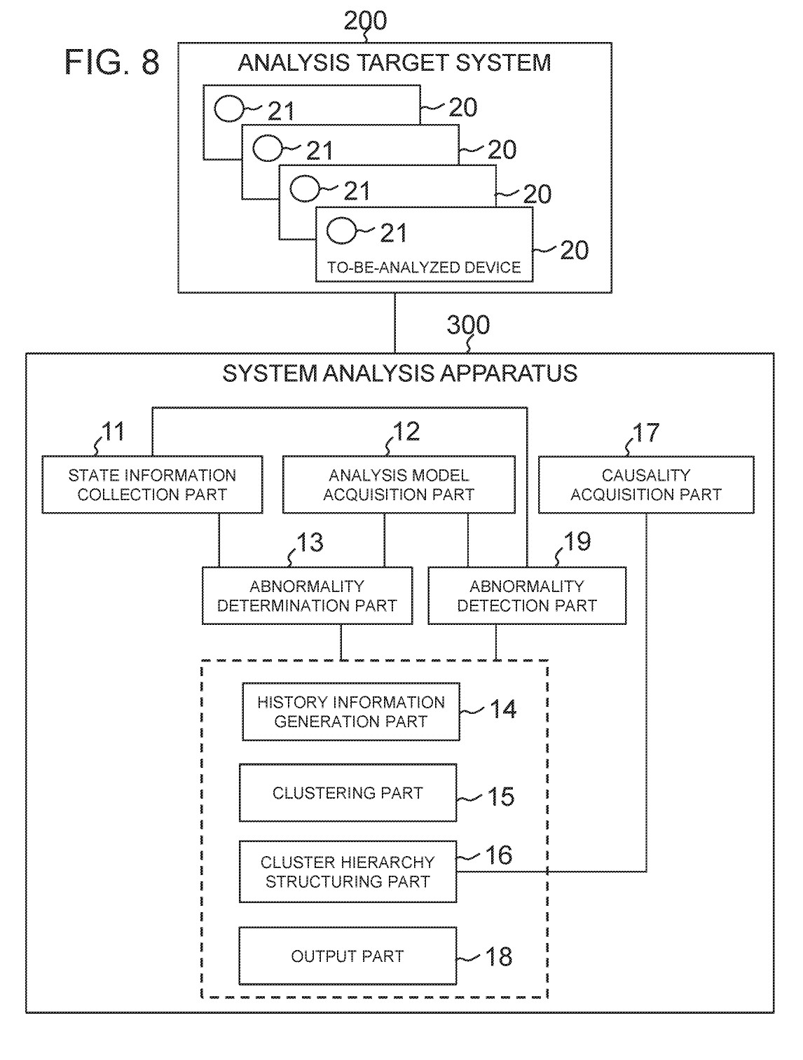

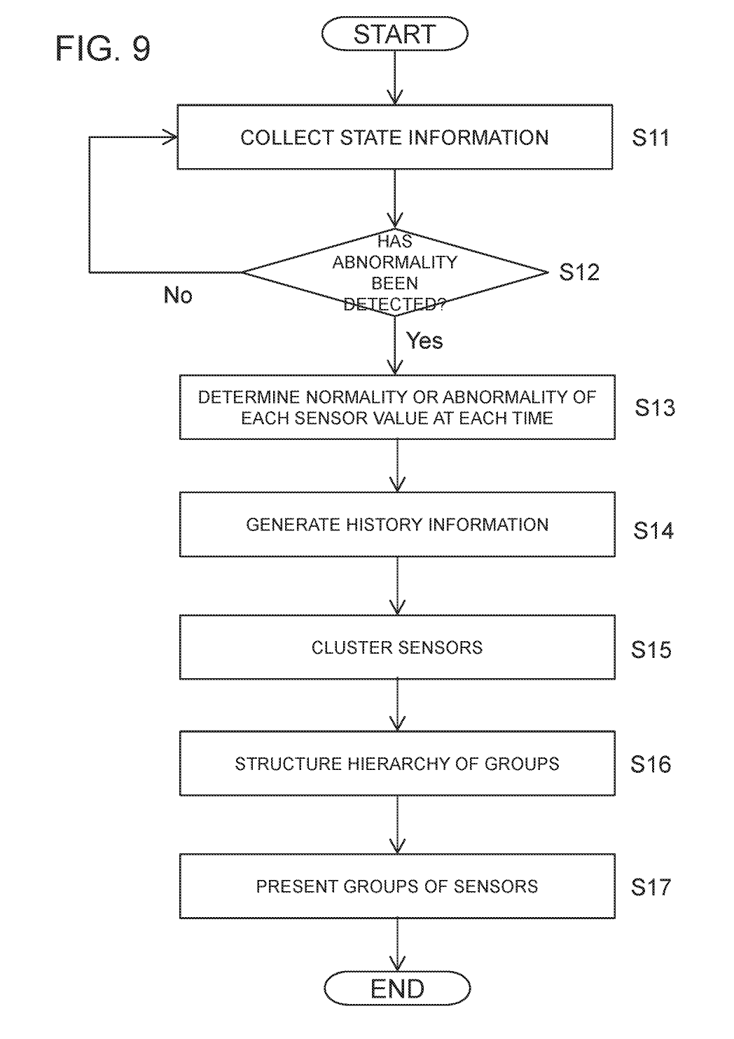

Next, a system analysis apparatus, a system analysis method, and a program according to a second example embodiment are described with reference to FIG. 8 and FIG. 9.

### Configuration

First, a configuration of a system analysis apparatus according to the second example embodiment is described with reference to FIG. 8. FIG. 8 is a block diagram illustrating an example of a specific configuration of a system analysis apparatus 300 according to this example embodiment.

As illustrated in FIG. 8, the system analysis apparatus 300 according to this example embodiment includes an abnormality detection part 19, unlike the system analysis apparatus 100 according to the first example embodiment illustrated in FIG. 2 and FIG. 3. Other than this difference, the system analysis apparatus 300 has a similar configuration to the configuration of the system analysis apparatus 100. Differences between this example embodiment and the first example embodiment will be mainly described below.

The abnormality detection part 19 detects abnormality of the analysis target system 200, the to-be-analyzed devices 20, or the sensors 21, based on state information collected by the state information collection part 11. Specifically, the abnormality detection part 19 compares a sensor value contained in the state information with a predetermined abnormality detection condition, and detects abnormality when the sensor value satisfies the abnormality detection condition, the abnormality detection part 19.

Further, in this example embodiment, the abnormality detection condition is set by using a sensor value of a specific sensor 21, an increase and decrease range of the sensor value, and the like, and further by combining these. The abnormality detection condition may be an abnormality detection condition set in an analysis model.

In this example embodiment, the history information generation part 14 generates history information, based on a time point when abnormality is detected by the abnormality detection part 19. For example, a target time period in which the history information is generated may be a past predetermined time period with respect to the time point when abnormality is detected. The length of the predetermined time period may be arbitrarily specified by the user. A start point of the predetermined time period may be the oldest time analyzed by using an analysis model in a time period when abnormality occurred, or may be a time point when the immediately preceding clustering has been executed. An end point of the predetermined time period may be a time point moved backward or forward by predetermined adjustment, such as a time point obtained by putting back a time point when abnormality is detected by a predetermined time period, and a time point obtained by putting forward a time point when abnormality is detected by a predetermined time period.

The causality acquisition part 17 may estimate causality information from the time series of the state information acquired by the state information collection part 11, or may acquire causality information from outside information that is independent of the time series of the state information.

In the former case, for example, the causality acquisition part 17 may use a general data analysis technology to estimate causality between the sensors 21 from the time series of the state information acquired by the state information collection part 11. Examples of this method include a method of estimating causality by calculating a cross correlation function while changing a time difference of two pieces of time series data, a method of using transfer entropy, a method of estimating a relationship between two sensors 21 with a regression formula and estimating causality from a time lag of a coefficient of the regression formula, a method of using cross mapping, and the like. The time series of the state information used to estimate causality may be, for example, specified by the user when clustering is executed, or may be determined in accordance with a preset rule. When the time series of the state information used to estimate causality is determined in accordance with a preset rule, for example, the time series may range from a time point when clustering is performed to a time point preceding the time point when clustering is performed by a time period predetermined by the operator. The time series may range from the time point when clustering is performed to time when the abnormality determination part 13 determines that a predetermined number of sensors 21 are abnormal. Further, the time series may range from the time point when clustering is performed to a time point further preceding the time when the abnormality determination part 13 determines that a predetermined number of sensors 21 are abnormal by a predetermined time period. The time series may be a time period set in accordance with a predetermined rule with respect to time when the abnormality detection part 19 detected abnormality.

In contrast, in the latter case, the causality acquisition part 17 may estimate causality between the sensors 21, based on knowledge of an expert and an equation relating to the system operation, for example.

### Operation

Next, operation of the system analysis apparatus 300 according to this example embodiment is described with reference to FIG. 9. FIG. 9 is a flowchart illustrating an example of the operation of the system analysis apparatus 300 according to this example embodiment. The description below refers to FIG. 8 as appropriate. In this example embodiment, a system analysis method is implemented by operating the system analysis apparatus 300. Therefore, the system analysis method according to this example embodiment is described by referring to the following operation of the system analysis apparatus 300.

Here, as a premise, it is assumed that the analysis model acquisition part 12 has acquired an analysis model in advance.

As illustrated in FIG. 9, the state information collection part 11 collects state information in a predetermined time period from the analysis target system 200 (Step S11).

Next, the abnormality detection part 19 performs detection of abnormality, based on the state information collected in Step S11, and determines whether abnormality has been detected (Step S12). When abnormality has not been detected as a result of the determination (No in Step S12), Step S11 is executed again after a predetermined time period elapses.

On the other hand, when abnormality has been detected as a result of the determination (Yes in Step S12), the abnormality determination part 13 applies the state information to the analysis model that has been acquired by the analysis model acquisition part 12 in advance to determine normality or abnormality for each sensor 21 at each time (Step S13).

Next, the history information generation part 14 generates history information, based on the determination result of normality or abnormality of each sensor 21 or each relationship between the sensors 21 obtained by the abnormality determination part 13 concerning a past predetermined time period with respect to the time point of abnormality detection in Step S12 (Step S14).

Next, the clustering part 15 clusters the sensors 21 included in the analysis model into one or more groups, based on the history information generated in Step S14 (Step S15).

Next, the cluster hierarchy structuring part 16 structures a hierarchy of the groups generated in Step S15, based on the causality information between the sensors 21 acquired from the causality acquisition part 17 (Step S16).

Next, the output part 18 presents the user (e.g., an operator), the system, and the like. with the groups of the sensors 21 obtained in the clustering in Step S15 and a hierarchy structure of the groups obtained in Step S16 (Step S17).

Through the above operation, the processing of the system analysis apparatus 300 ends. When state information is output from the analysis target system 200 after a predetermined time period elapses, the system analysis apparatus 300 executes Steps S11 to S17 of FIG. 9 again.

### Effects

As in the description above, according to the system analysis apparatus 300 of this example embodiment, similar effects to the effects of the system analysis apparatus 100 according to the first example embodiment can be obtained. Further, in this example embodiment, abnormality detection is performed, and thus a time period in which history information is generated is automatically set. Therefore, according to this example embodiment, load when the operator operates the system can be significantly reduced.

### Program

A program according to this example embodiment causes a computer to execute Steps S11 to S17 illustrated in FIG. 9. When this program is installed in a computer and is executed, the system analysis apparatus 300 and the system analysis method according to this example embodiment can be implemented. In this case, a central processing unit (CPU) of the computer performs processing while functioning as the state information collection part 11, the analysis model acquisition part 12, the abnormality determination part 13, the history information generation part 14, the clustering part 15, the cluster hierarchy structuring part 16, the causality acquisition part 17, the output part 18, and the abnormality detection part 19.

The program according to this example embodiment may be executed by a computer system constructed by a plurality of computers. In this case, for example, each of the computers may function as any of the state information collection part 11, the analysis model acquisition part 12, the abnormality determination part 13, the history information generation part 14, the clustering part 15, the cluster hierarchy structuring part 16, the causality acquisition part 17, the output part 18, and the abnormality detection part 19.

Further, the program according to this example embodiment may be stored in a storage device of a computer that implements the system analysis apparatus 300, and may be read out by a CPU of the computer to be executed. In this case, the program may be provided as a computer-readable storage medium, or may be provided via a network.

Incidentally, the above-mentioned first and second example embodiments describe a case where the analysis target system 200 is a power generation plant system. However, in the present invention, the analysis target system 200 is not limited thereto. Examples of the analysis target system 200 also include an information technology (IT) system, a plant system, a construction, transportation equipment, and the like. Also in these cases, the system analysis apparatus 100 (or 300) can cluster data items by using, as data items, types of data contained in information indicating a state of the analysis target system.

Further, the above-mentioned first and second example embodiments mainly describe an example where each functional block of the system analysis apparatus 100 (or 300) is implemented by a CPU that executes a computer program stored in a storage device or read only memory (ROM). However, the present invention is not limited thereto. In the system analysis apparatus 100 (or 300) of the present invention, all the functional blocks may be implemented by dedicated hardware, or a part of the functional blocks may be implemented by hardware and the rest of the functional blocks may be implemented by software.

In the present invention, the above-mentioned first and second example embodiments may be carried out in combination as appropriate. Further, the present invention is not limited to each of the above-mentioned example embodiments, and may be carried out in various aspects.

### Physical Configuration

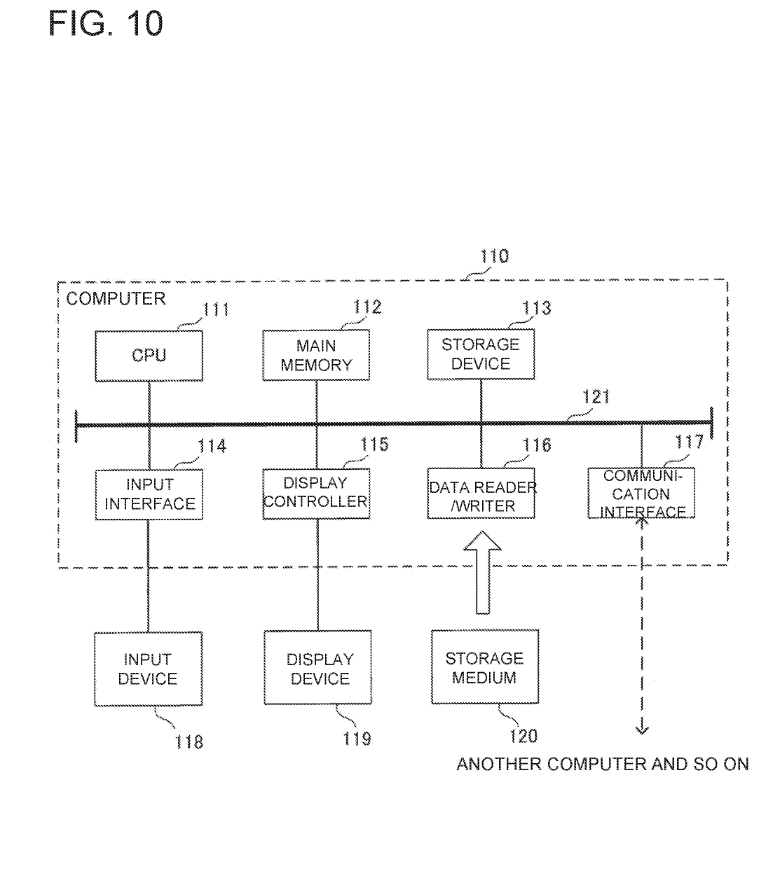

Now, a computer that implements the system analysis apparatuses by executing the programs according to the first and second example embodiments is described with reference to FIG. 10. FIG. 10 is a block diagram illustrating an example of a computer that implements the system analysis apparatuses 100 and 300 according to the first and second example embodiments.

With reference to FIG. 10, a computer 110 includes a central processing unit (CPU) 111, a main memory 112, a storage device 113, an input interface 114, a display controller 115, a data reader/writer 116, and a communication interface 117. These components are connected to each other via a bus 121 such that the components can communicate data with each other.

The CPU 111 expands the program (code) according to the first or second example embodiment stored in the storage device 113 into the main memory 112, and executes the expanded program (code) in predetermined order to perform various types of calculation. The main memory 112 is typically a volatile storage device such as a dynamic random access memory (DRAM). The program according to the first or second example embodiment is provided in a state of being stored in a computer-readable storage medium 120. Note that the program according to this example embodiment may be a program distributed on the Internet connected via the communication interface 117.

Specific examples of the storage device 113 include a semiconductor storage device such as flash memory, as well as a hard disk drive (HDD). The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the storage medium 120, and reads out the program from the storage medium 120 and writes a processing result of the computer 110 to the storage medium 120. The communication interface 117 mediates data transmission between the CPU 111 and another computer.

Specific examples of the storage medium 120 include a widely used semiconductor storage device such as Compact Flash (CF (trademark)) and Secure Digital (SD), a magnetic storage medium such as a flexible disk, and an optical storage medium such as a compact disk read only memory (CD-ROM).

As described above, according to the above-mentioned example embodiments, when a plurality of types of abnormalities occur in a system to be analyzed, the abnormalities can be separated according to the types, and information for each type can be output. As one example, the present invention can be suitably applied to the purpose of abnormality diagnosis of a system.

Note that the present invention is possible in the following modes.
[Mode 1]

A system analysis method according to the above-mentioned first aspect.
[Mode 2]

The system analysis method according to Mode 1, including the steps of:

identifying, based on the history information, a continuous time period of continuation of abnormality of each of the sensor values output by the plurality of sensors, and/or abnormality of the relationship between the sensor values output by different sensors; and classifying the plurality of sensors into the plurality of groups, based on a length of the continuous time period.
[Mode 3]

The system analysis method according to Mode 2, in which the plurality of sensors are classified into the plurality of groups, based on a total length of the continuous time periods included in a predetermined time period, or a length of a latest time period of the continuous time periods included in the predetermined time period.
[Mode 4]

The system analysis method according to any one of Modes 1 to 3, including the step of:

acquiring the causality information that is defined in advance; or

generating the causality information by estimating causality between the sensor values output by the plurality of sensors, based on the sensor values output by the plurality of sensors.
[Mode 5]

The system analysis method according to any one of Modes 1 to 4, including the steps of:

estimating a start time when abnormality started in the sensor values output by the sensors included in each of the plurality of groups; and

structuring a hierarchy of the plurality of groups by using the causality information and the start time.
[Mode 6]

The system analysis method according to any one of Modes 1 to 5, including the steps of:

detecting abnormality, based on the sensor values; and

generating the history information and/or the causality information concerning a predetermined time period preceding a time when the abnormality is detected.
[Mode 7]

A system analysis apparatus according to the above-mentioned second aspect.
[Mode 8]

The system analysis apparatus according to Mode 7, in which the history information generation part identifies, based on the history information, a continuous time period of continuation of abnormality of each of the sensor values output by the plurality of sensors, and/or abnormality of the relationship between the sensor values output by different sensors, and

the clustering part classifies the plurality of sensors into the plurality of groups, based on a length of the continuous time period.
[Mode 9]

The system analysis apparatus according to Mode 8, in which the clustering part classifies the plurality of sensors into the plurality of groups, based on a total length of the continuous time periods included in a predetermined time period, or a length of a latest time period of the continuous time periods included in the predetermined time period.
[Mode 10]

The system analysis apparatus according to any one of Modes 7 to 9, including

a causality acquisition part configured to acquire the causality information that is defined in advance, or generate the causality information by estimating causality between the sensor values output by the plurality of sensors, based on the sensor values output by the plurality of sensors.
[Mode 11]

The system analysis apparatus according to any one of Modes 7 to 10, in which

the clustering part estimates a start time when abnormality started in the sensor values output by the sensors included in each of the plurality of groups, and

the cluster hierarchy structuring part structures a hierarchy of the plurality of groups by using the causality information and the start time.
[Mode 12]

The system analysis apparatus according to any one of Modes 7 to 11, including

an abnormality detection part configured to detect abnormality, based on the sensor values, wherein

the history information generation part generates the history information concerning a predetermined time period preceding a time when the abnormality is detected, and/or

the causality acquisition part generates the causality information concerning the predetermined time period preceding the time when the abnormality is detected.
[Mode 13]

A program according to the above-mentioned third aspect.

Note that all the contents disclosed in the above-mentioned Patent Literatures are incorporated and described herein by reference thereto. Making a change and adjustment of the example embodiments is allowed within the framework of the entire disclosure (including the claims) of the present invention, and also based on a basic technical concept of the present invention. Further, various combination or selection of various disclosed elements (including each element of each claim, each element of each example embodiment, each element of each drawing, and the like) is allowed within the framework of the entire disclosure of the present invention. Specifically, as a matter of course, the present invention encompasses various variants and amendments that may be achieved by a person skilled in the art based on the entire disclosure including the claims and the technical concept. Regarding a range of a numerical range described herein, in particular, it should be interpreted that any numerical value or any smaller range included within the range is specifically described even without particular description.

### REFERENCE SIGNS LIST

10, 100, 300 System analysis apparatus

11 State information collection part

12 Analysis model acquisition part

13 Abnormality determination part

14 History information generation part

15 Clustering part

16 Cluster hierarchy structuring part

17 Causality acquisition part

18 Output part

19 Abnormality detection part

20 To-be-analyzed device

21 Sensor

110 Computer

111 Central processing unit (CPU)

112 Main memory

113 Storage device

114 Input interface

115 Display controller

116 Data reader/writer

117 Communication interface

118 Input device

119 Display device

120 Storage medium

121 Bus

200 Analysis target system

What is claimed is:

1. A system analysis method, comprising:
generating, based on sensor values output by a plurality of sensors provided in a system, history information representing in a time series whether or not the sensor value(s) output by each of the plurality of sensors is abnormal, and/or whether or not a relationship between the sensor values output by different sensors is abnormal;
classifying the plurality of sensors into a plurality of groups, based on the history information; and
structuring a hierarchy of the plurality of groups by using causality information that indicates causality between the sensor values output by the plurality of sensors.

2. The system analysis method according to claim 1, comprising:
identifying, based on the history information, a continuous time period of continuation of abnormality of the sensor values output by each of the plurality of sensors, and/or abnormality of the relationship between the sensor values output by different sensors; and
classifying the plurality of sensors into the plurality of groups, based on a length of the continuous time period.

3. The system analysis method according to claim 2, wherein
the plurality of sensors are classified into the plurality of groups, based on a total length of the continuous time periods included in a predetermined time period, or a length of a latest time period of the continuous time periods included in the predetermined time period.

4. The system analysis method according to claim 1, comprising:
acquiring the causality information that is defined in advance; or
generating the causality information by estimating causality between the sensor values output by the plurality of sensors, based on the sensor values output by the plurality of sensors.

5. The system analysis method according to claim 1, comprising:
estimating a start time when abnormality started in the sensor values output by the sensors included in each of the plurality of groups; and
structuring a hierarchy of the plurality of groups by using the causality information and the start time.

6. The system analysis method according to claim 1, comprising:
detecting abnormality, based on the sensor values; and
generating the history information and/or the causality information concerning a predetermined time period preceding a time when the abnormality is detected.

7. A system analysis apparatus, comprising:
a memory storing a program including instructions, and a processor configured to execute the program to perform the instructions including:
history information generating, based on sensor values output by a plurality of sensors provided in a system, history information representing in a time series whether or not the sensor value(s) output by each of the plurality of sensors is abnormal, and/or whether or not a relationship between the sensor values output by different sensors is abnormal;
classifying the plurality of sensors into a plurality of groups, based on the history information; and
cluster hierarchy structuring a hierarchy of the plurality of groups by using causality information that indicates causality between the sensor values output by the plurality of sensors.

8. The system analysis apparatus according to claim 7, wherein
the history information generating identifies, based on the history information, a continuous time period of continuation of abnormality of the sensor value(s) output by each of the plurality of sensors, and/or abnormality of the relationship between the sensor values output by different sensors, and
the classifying classifies the plurality of sensors into the plurality of groups, based on a length of the continuous time period.

9. The system analysis apparatus according to claim 8, wherein
the classifying classifies the plurality of sensors into the plurality of groups, based on a total length of the continuous time periods included in a predetermined time period, or a length of a latest time period of the continuous time periods included in the predetermined time period.

10. The system analysis apparatus according to claim 7, comprising:
acquiring the causality information that is defined in advance, or generate the causality information by estimating causality between the sensor values output by the plurality of sensors, based on the sensor values output by the plurality of sensors.

11. The system analysis apparatus according to claim 7, wherein
the clustering hierarchy structuring estimates a start time when abnormality started in the sensor values output by the sensors included in each of the plurality of groups, and
the cluster hierarchy structuring includes structuring a hierarchy of the plurality of groups by using the causality information and the start time.

12. The system analysis apparatus according to claim 7, comprising:
detecting abnormality, based on the sensor values, wherein
the history information generating generates the history information concerning a predetermined time period preceding a time when the abnormality is detected, and/or
the causality information is generated concerning the predetermined time period preceding the time when the abnormality is detected.

13. A non-transitory computer-readable recording medium storing thereon a program, configured to cause a computer to execute processes of:
generating, based on sensor values output by a plurality of sensors provided in a system, history information representing in a time series whether or not the sensor value(s) output by each of the plurality of sensors is abnormal, and/or whether or not a relationship between the sensor values output by different sensors is abnormal;
classifying the plurality of sensors into a plurality of groups, based on the history information; and
structuring a hierarchy of the plurality of groups by using causality information that indicates causality between the sensor values output by the plurality of sensors.
